(19) United States
(12) Patent Application Publication
(10) Pub. No.: US 2026/0287799 A1
(43) Pub. Date: Sep. 24, 2026

(54) TRANSPARENT OPTICAL STRUCTURE AND MANUFACTURING METHOD THEREOF

(71) Applicant: STMicroelectronics International N.V., Geneva (CH)

(72) Inventors: Maxime ARGOUD, La Chapelle De La Tour (FR); Francois GUYADER, Montbonnot (FR); Pierre TISSIER, Grenoble (FR)

(73) Assignee: STMicroelectronics International N.V., Geneva (CH)

(21) Appl. No.: 19/558,129

(22) Filed: Mar. 5, 2026

(30) Foreign Application Priority Data
Mar. 19, 2025 (FR) FR2502795

(51) Int. Cl. G02B 5/02; G02B 1/14

(52) U.S. Cl. CPC G02B 5/0236; G02B 1/14; G02B 5/0268; G02B 5/0278

(57) ABSTRACT

The present description concerns a method for manufacturing a transparent optical structure 10, including a step of making a protective layer covering a conductive layer 21, by CVD deposition under vacuum, with thermally exposing to a first temperature T1 greater than, or equal to within 10%, to a second temperature T2 at least equal to 300°C for a first duration Δt1 greater than, or equal to within 10%, a second duration Δt2 at least equal to 60min; and then a subsequent step of thermally exposing to the temperature T2 for the duration Δt2.

### BACKGROUND

### Technical Field

The present description generally relates to transparent optical structures, such as especially optical diffusers, as well as to manufacturing methods thereof.

### Description of the Related Art

Optical diffusers, such as, for example, Diffractive Optical Elements (DOE) and Meta Optical Elements (MOE), can be used to transmit and orient and/or shape incident light beams passing therethrough.

They can be used in display or image detection, Light Detection And Ranging (LIDAR), Time of Flight (ToF) applications, inter alia.

They may include a transparent layer located between two anti-reflective layers, this transparent layer having an optical diffusion or even diffraction function, by means of diffusing structures encapsulated in a transparent material with a different refractive index.

They may also comprise a thin conductive track, made of a transparent and electrically conductive material, extending on one face of the diffusing layer. Such a thin conductive track can be connected to an electric current source, and can thus make it possible to verify integrity of the optical diffuser. Indeed, interruption of the electric current can thus reveal a structural defect of the optical diffuser.

These transparent optical structures can be manufactured, for example collectively from a same wafer, by thin film deposition techniques.

However, there is a need for a method for manufacturing such transparent optical structures making it possible to reduce the risk of degradation of electrical and optical properties of the thin conductive track during the steps of the method.

### BRIEF SUMMARY

According to one aspect of the present disclosure, a method for manufacturing a transparent optical structure is provided, including the following steps:

forming a transparent layer;

forming a conductive layer, made of a transparent and electrically conductive material, on a face of the transparent layer;

forming a protective layer, made of a transparent and electrically insulating material, covering the conductive layer, by chemical vapor deposition;

forming a conductive track, covered with a protective track, by lithography and etching the protective layer and the conductive layer;

forming an encapsulation layer, made of a transparent and electrically insulating material, covering the transparent layer, the protective track and the conductive track.

Forming the protective layer can be performed by chemical vapor deposition under vacuum.

Forming the protective layer may include thermally exposing the conductive layer to a first temperature T1 greater than, or equal to within 10%, to a second temperature T2 at least equal to 300°C for a first duration Δt1 greater than, or equal to within 10%, to a second duration Δt2 at least equal to 60min.

The method may include, following the step of making the encapsulation layer, a step of thermally exposing to the second temperature T2 for the second duration Δt2.

Making the protective layer may include:

thermally exposing to the first temperature T1 for the first duration Δt1, performed in an enclosure of a chemical vapor deposition reactor, formation precursors of the protective layer not being present in the enclosure; and then

forming the protective layer in the enclosure by injecting the precursors.

After the transparent optical structure leaves a layer deposition reactor used during the step of forming the conductive layer, until introducing the transparent optical structure into a CVD reactor used during the step of forming the protective layer, the protective layer may remain at a temperature less than or equal to 100°C in an environment at atmospheric pressure.

The conductive layer may be made of an oxide.

The protective layer may be made of a silicon oxide or nitride.

The temperature T1 and the temperature T2 may be between 300°C and 400°C.

During the step of forming the protective layer, the pressure is between 1 and 10 Torr.

The method may include a step of assembling a transparent substrate on the encapsulation layer, by direct bonding, during which the step of thermally exposing to the temperature T2 is performed for the duration Δt2.

The method may include a step of making an additional layer, during which the step of thermally exposing to the temperature T2 is performed for the duration Δt2.

According to another aspect, a transparent optical structure is provided, including:

a transparent layer;

a conductive track, extending on a face of the transparent layer, made of a transparent and electrically conductive material;

a protective track, covering a face of the conductive track opposite to the transparent layer, made of a transparent and electrically insulating material;

an encapsulation layer, made of a transparent and electrically insulating material, covering the transparent layer, the protective track and the conductive track.

The transparent layer, the protective track, and the encapsulation layer may be made of silicon-based materials, and the conductive track may be made of a transparent conductive oxide.

The transparent optical structure may further include a transparent substrate assembled by direct bonding to the encapsulation layer, or an additional layer covering the encapsulation layer.

The conductive track may have a thickness between 5nm and 200nm, and the protective track may have a thickness between 5nm and 200nm.

According to another aspect, an optical diffuser is provided, including: the transparent optical structure according to any one of the preceding characteristics, wherein the transparent layer is a diffusing layer comprising diffusing structures arranged in a main plane of the transparent layer and located in an encapsulating material having a refractive index different from that of the diffusing structures.

### BRIEF DESCRIPTION OF THE SEVERAL VIEWS OF THE DRAWINGS

Other advantages and characteristics of the various embodiment of present disclosure will become apparent upon examining the detailed description of non-limiting embodiments and implementations, and from the appended drawings wherein:

FIG. 1A is a schematic and partial view of an example optical diffuser including a transparent optical structure;

FIG. 1B is a schematic view of a part of the optical diffuser of FIG. 1A; and

FIG. 2A, FIG. 2B, FIG. 2C, FIG. 2D, FIG. 2E, FIGS. 2F and FIG. 2G illustrate different steps of a method for manufacturing an optical diffuser, including a transparent optical structure according to one embodiment.

### DETAILED DESCRIPTION

In the figures and in the following description, same references represent identical or similar elements. In addition, the different elements are not plotted to scale so as to favor clarity of the figures. Moreover, the different embodiments and alternatives are not exclusive of each other and may be combined together.

Unless indicated otherwise, the terms “substantially,” “about,” “in the order of” mean to within 10%, and preferably to within 5%. Moreover, the terms “between … and …” and equivalents thereof mean that the bounds are included, unless stated otherwise.

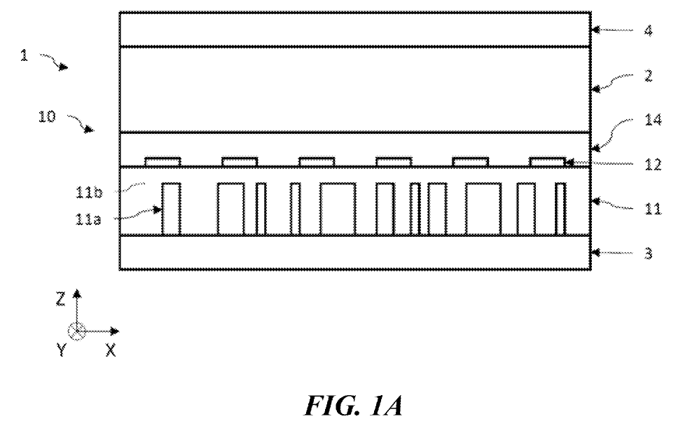

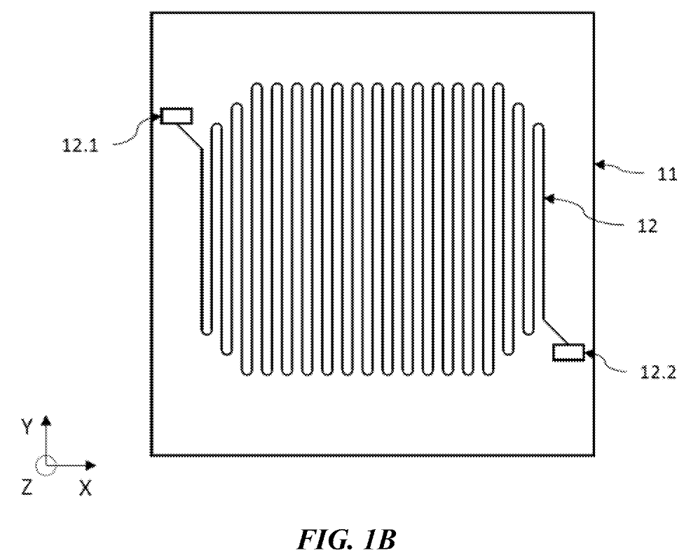

FIG. 1A is a schematic and partial view of an example of optical diffuser 1 including a transparent optical structure 10.

Herein and for the remainder of the description, a three-dimensional right-handed reference frame XYZ is defined, in which the plane XY is parallel to the main plane of the transparent optical structure, and in which the axis Z is oriented along the thickness thereof. Furthermore, the terms “lower” and “upper” are understood to be relative to an increasing positioning along the direction +Z.

By way of example, such an optical diffuser 1 may be for transmitting and shaping and/or orienting an incident light beam. It may be a continuous or pulsed light beam, for example a laser beam, the wavelength of which may be included in the spectral range of Near Infrared (NIR) ranging from about 780 nm to 2500 nm. For example, the working wavelength may be equal to 940 nm.

In this example, the optical diffuser includes the transparent optical structure 10 to which a transparent substrate 2 is assembled by direct bonding. The assembly is located between two anti-reflective layers 3 and 4.

The transparent optical structure 10 includes a transparent layer 11 having an optical function of diffusion or even diffraction of the incident light beam. The transparent layer 11 is herein a diffusing layer including diffusing structures 11a encapsulated in a transparent and electrically insulating material 11b. The material of the diffusing structures 11a and the encapsulating material 11b have different refractive indices.

In general, transparent means that the transmission coefficient of the material considered, at a working wavelength that depends on the intended application, is at least equal to 50%, or even 75%, or even 90% or more.

The diffusing structures 11a are herein pads or pillars made from silicon, for example of polycrystalline silicon or amorphous silicon, which extend vertically from the lower face of the transparent layer 11. The encapsulating material 11b may be a nitride or an oxide, for example a silicon oxide. It surrounds the diffusing structures 11a in the horizontal plane XY. Here, it ensures a non-zero spacing between the upper surface of the diffusing structures 11a and the upper face of the transparent layer 11, so that the diffusing structures 11a are not flush with the upper face of the transparent layer 11.

The transparent layer 11 rests on a first anti-reflective layer 3, here formed by alternating elementary layers of transparent and electrically insulating materials, having different refractive indices, for example a silicon oxide and a silicon nitride.

A thin conductive track 12 rests and extends over the upper face of the transparent layer 11. It is made of a transparent and electrically conductive material, and can be an oxide such as TCO (Transparent Conductive Oxide). By way of example, it may be an Indium Tin Oxide (ITO). This is a track (or line) insofar as, in the plane XY, the length thereof is greater than the width thereof. It is said to be thin insofar as it has a thickness in the order of a few dozen nanometers, for example between 5nm and 100nm, for example 40nm, its thickness being less than its length and width.

FIG. 1B illustrates an example of a thin conductive track 12, which extends over the face of the transparent layer 11 as a serpentine. Of course, it can extend in different ways, for example in a circular manner.

The thin conductive track 12 extends in the plane XY between two end portions 12.1, 12.2. The end portions ensure electrical connection of the thin conductive track 12 with connection pads (not represented).

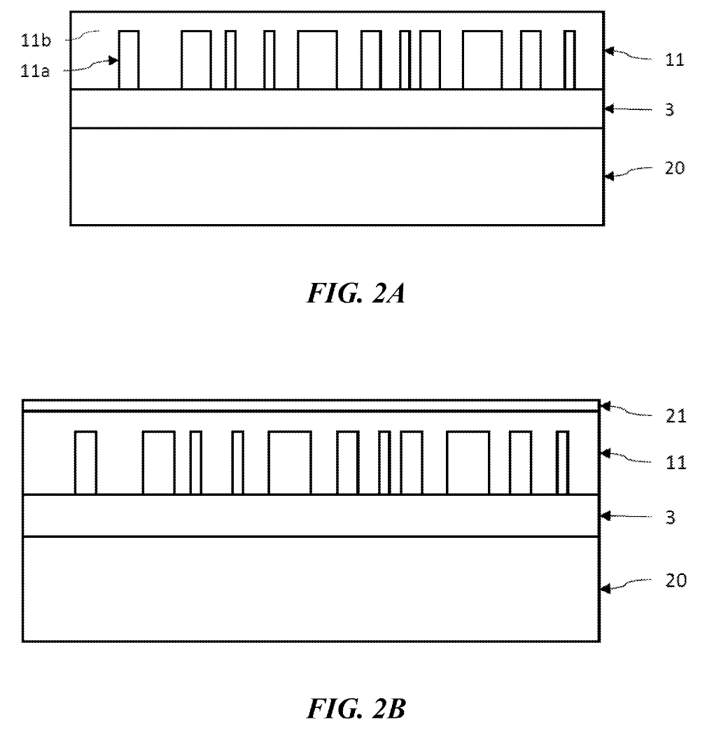

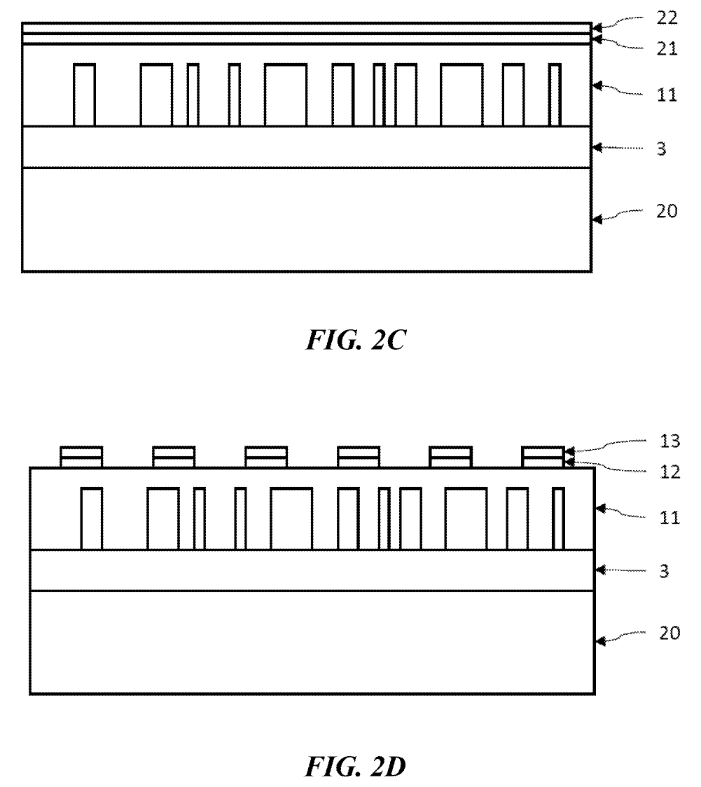

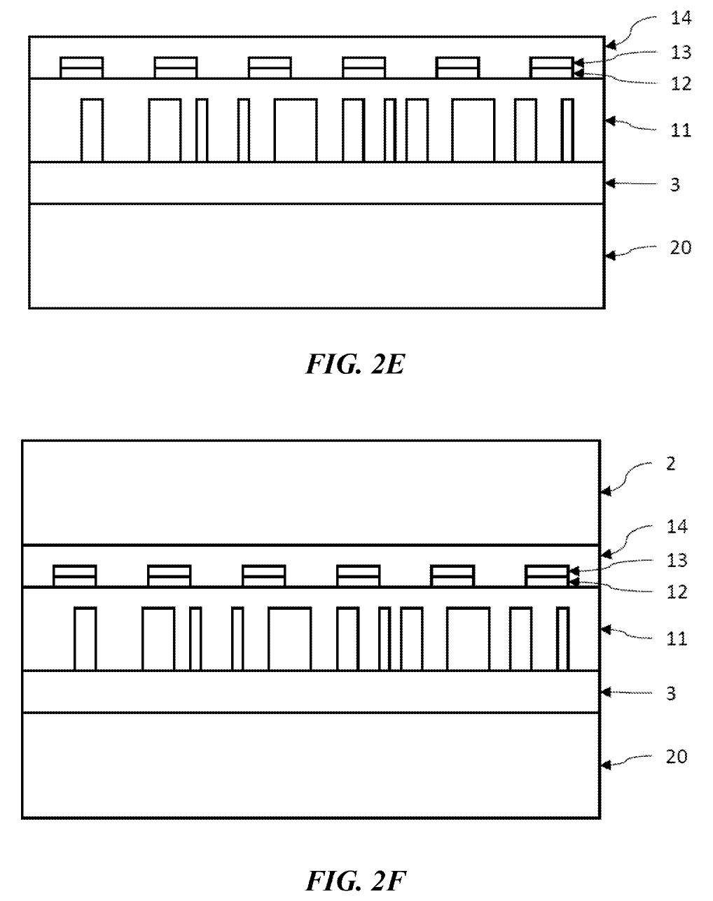

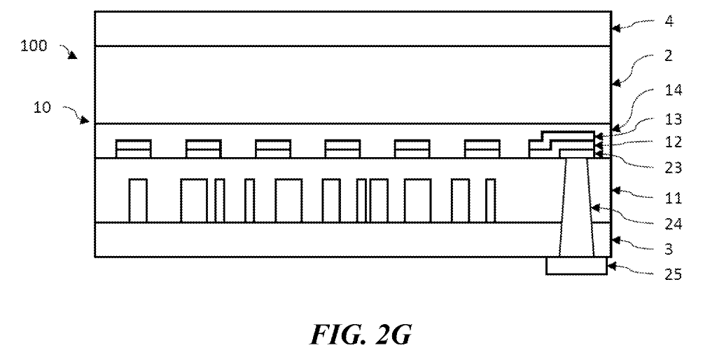

The electrical connection pads can be electrically connected to the thin conductive track 12 by means of conductive vias passing through the first anti-reflective layer 3 and the transparent layer 11. An example of conductive vias and connection pads is illustrated in FIG. 2G.

The transparent layer 11 and the thin conductive track 12 are covered with an encapsulation layer 14 made of a transparent and electrically insulating material, for example an oxide such as a silicon oxide.

In this example, a transparent substrate 2, for example made of glass, is assembled by direct bonding to the upper face of the encapsulation layer 14. Consolidation annealing may accompany or follow the direct bonding step so as to improve the bonding strength. Such consolidation annealing may be performed at about 380°C for 2 h.

It should be noted that direct bonding, also called molecular bonding or molecular adhesion bonding, is the securing of two layers in contact with each other, without delivering a specific adhesive material such as a resin or a polymer, but by means of the attractive forces of atomic or molecular interaction between the surfaces to be bonded, such as Van der Waals forces or covalent or metallic bonds. This is a spontaneous bonding method, which, like here, may be temperature-assisted.

Finally, a second anti-reflective layer 4, identical or similar to the first anti-reflective layer 3, extends over the upper face of the transparent substrate 2.

However, it appears that the electrical and optical properties of the thin conductive track 12 may be impaired during the manufacturing method. Indeed, the inventors have noticed that the sheet resistance as well as the refractive index n and the extinction coefficient k can be degraded during the steps of the method. In the context of a collective manufacture of the transparent optical structures on a same wafer, this may result in a spatial uniformity defect of the electrical and optical properties from one transparent optical structure to the other.

In order to limit this impairment of the optical and electrical properties of the thin conductive track 12, it could be contemplated to perform stabilization annealing between, on the one hand, the step of depositing the thin conductive layer intended to form the thin conductive track 12, and, on the other hand, the lithography and etching steps to obtain the thin conductive track 12. Such a stabilization annealing can be identical to the consolidation annealing, and can herein be performed at 380°C for 2h.

However, the inventors have noticed that such a stabilization annealing not only did not accompany an improvement in the electrical and optical properties of the thin conductive track, but could even worsen degradation of the electrical and optical properties.

Thus, by way of example, measurements of the sheet resistance Rs of the thin conductive layer have been performed as part of a collective manufacturing method. As a reminder, the sheet resistance Rs is defined as the inverse of the product of electrical conductivity and layer thickness. It is expressed in ohms per square (Ω/sq). It can be measured using a four-point probe at different points of the wafer, for example along different radii, so as to be able to estimate spatial variation in the sheet resistance Rs over the entire surface of the wafer.

A first series of measurements is performed in the case where the manufacturing method does not include stabilization annealing after the deposition of the thin conductive layer: the method thus includes a so-called “EPVD” of physical vapor deposition (PVD) of the thin conductive layer, a so-called “ELG” step of lithography and etching to form the thin conductive track, a so-called “ECE” step of making the encapsulation layer, and then a subsequent so-called “EET2” step of thermal exposure (here during direct bonding).

A second series of measurements is performed in the case where the manufacturing method is similar to the previous one, and is distinguished therefrom in that it also includes a stabilization annealing R1 at 380°C for 2h, performed after the EPVD step and before the ELG step. In this case, the structure obtained following the EPVD step is removed from the PVD reactor and placed in an annealing furnace (similar or identical to that used during the direct bonding step EET2).

For each wafer, the sheet resistance Rs is measured at different points of its surface, then a mean value, at the scale of the wafer, as well as a relative standard deviation (standard deviation made dimensionless by the mean value) representative of the dispersion of the values about the mean, are calculated. Each series of measurements is performed on a plurality of wafers.

The first series of measurements shows that the resistance Rs has a mean value between about 67 and 205Ω/sq with a relative standard deviation between about 4.2 and 7.5%. Moreover, the second series of measurements shows that the resistance Rs has a mean value between about 59 and 87Ω/sq with a relative standard deviation of about 13%. Thus, it appears that a stabilization annealing step R1 performed after the PVD step EPVD of depositing the thin conductive layer leads to a degradation in the spatial uniformity of the resistance Rs (increase in the relative standard deviation). This degradation in spatial uniformity can therefore result in an impairment of the electrical (and therefore also optical) properties of each of the transparent optical structures.

However, the inventors have noticed that the fact of covering the thin conductive layer with a thin protective layer, before the structuring (lithography and etching) step ELG to form the thin conductive track, this thin protective layer being made by Chemical Vapor Deposition (CVD), under vacuum, this step called “ECVD” including a thermal exposure called “EET1” at a temperature greater than or equal to within 10% to the subsequent thermal exposure temperature EET2, made it possible to reduce risks of degradation of electrical and optical properties during the manufacturing method.

This approach generally applies in the case where the manufacturing method includes, after the step ECE of making the encapsulation layer, a step EET2 of subsequent thermally exposing to a temperature T2 at least equal to 300°C, for example between 300°C and 400°C, for a duration Δt2 at least equal to 60min, or even 90min. This subsequent thermal exposure step EET2 may be the consolidation annealing associated with the direct bonding of a transparent substrate, but may also be associated with any other step of the manufacturing method, for example when making one or more additional, for example anti-reflective, layers.

In the remainder of the description, it will therefore be a matter of a thermal exposure step EET1, associated with making the thin protective layer by CVD under vacuum (step ECVD), performed at a temperature T1 for a duration of Δt1, where T1 is greater than T2 or at least equal to T2 to within 10% or even 5%, and where Δt1 is greater than Δt2 or at least equal to Δt2 to within 10% or even 5%; and a step of subsequent thermally exposing EET2 to the temperature T2 for the duration Δ t2, performed after making the encapsulation layer.

The thin protective layer is made by CVD deposition, preferably plasma-enhanced (PECVD, for Plasma-Enhanced Chemical Vapor Deposition) or by High Density Plasma CVD (HDPCVD), or even by Low Pressure CVD (LPCVD), among others.

The CVD deposition is performed under vacuum, i.e., at a pressure lower than atmospheric pressure, at least less than 20 Torr, preferably less than or equal to 10 Torr, and preferably between 1 and 10 Torr.

The thin protective layer is considered thin, insofar as it has a thickness in the order of a few tens to hundreds of nanometers, and is made by thin film deposition, here by CVD. Its thickness may be less than or equal to 200nm, for example be between 5nm and 200nm, preferably between 5nm and 100nm, or even between 5nm and 50nm. It can be equal to 20nm.

The thin protective layer is made of a transparent and electrically insulating material. This material may herein be an oxide, a nitride, or an oxynitride, such as for example SiO, SiN or SiON. By way of example, the thin protective layer may be made of a tetraethyl orthosilicate (TEOS). Preferably, its refractive index is substantially identical to that of the material of the thin conductive track, so as to reduce parasitic reflections.

FIGS. 2A to 2G illustrate different steps of a method for manufacturing a transparent optical structure 10 according to one embodiment, here in the context of manufacturing an optical diffuser 100.

As indicated previously, the transparent optical structure 10 is at least formed of a stack of a transparent layer 11 (here diffusive, or even diffractive), a thin conductive track 12 covered with a thin protective track 13, and then an encapsulation layer 14.

According to one embodiment, the transparent optical structure 10 also includes a transparent substrate 2 assembled to the encapsulation layer 14 by temperature-assisted direct bonding.

With reference to FIG. 2A, a first anti-reflective layer 3 is made from a support substrate 20. The latter may be made based on silicon, and the anti-reflective layer 3 may be formed from alternating elementary thin layers (sublayers) of materials having different refractive indices, such as for example silicon nitride and oxide.

The transparent, here diffusing, layer 11 is then made. For this, a continuous layer (not represented) of a transparent and electrically insulating material, for example an oxide such as SiO, is made on the anti-reflective layer. Diffusing structures 11a (here diffractive), such as pads or pillars, are made through the continuous layer. Finally, a new deposition of the material of the continuous layer is performed so as to cover the diffusing structures. A Chemical Mechanical Planarization (CMP) step may be performed to planarize the upper face of the transparent layer 11.

The transparent layer 11 here includes structures 11a that extend vertically from its lower face, and an encapsulating material 11b that surrounds the structures 11a in the plane XY and continuously covers them along the axis Z. The encapsulating material 11b thus defines the upper face of the transparent layer 11.

With reference to FIG. 2B, the thin conductive layer 21, which is for forming the thin conductive track 12, is then made (EPVD). The thin conductive layer 21 is made so as to cover the upper face of the transparent layer 11. It is made of a transparent and electrically conductive material, such as oxide (TCO). Preferably, it is an Indium Tin Oxide (ITO), but it may also be a Fluorine-doped Tin Oxide (FTO), an Aluminum-doped Zinc Oxide (AZO) or even Gallium-doped Tin Oxide (GTO), inter alia. It has a thickness in the order of a few dozen nanometers, for example between 5nm and 100nm, for example 40nm. It can be made by Physical Vapor Deposition (PVD) at a temperature of for example 150°C, inter alia.

Preferably, the method provides for maintaining the structure obtained at the end of the previous step (making the thin conductive layer 21, here by PVD deposition) until the next step (making the thin protective layer 22 by CVD deposition) at a temperature at most equal to 100°C, or even 50°C, and preferably at ambient temperature (25°C for example), and preferably at ambient pressure. In other words, after the structure leaving the PVD reactor after making the thin conductive layer 21, until it is introduced into the CVD reactor to make the thin protective layer 22, the structure preferably remains at ambient temperature (at most equal to 100°C or even 50°C) and at ambient pressure.

With reference to FIG. 2C, the thin protective layer 22 is then made (ECVD and EET1), so as to cover and be in contact with the thin conductive layer 21. It is performed by CVD deposition, here by PECVD, under vacuum, here at a pressure lower than atmospheric pressure, preferably between 1 and 10 Torr. The material of the thin protective layer 21 is transparent and electrically insulating. It is preferably TEOS, which has a refractive index close to that of ITO at the wavelength of 940nm, thereby limiting parasitic reflections. The thickness of the thin protective layer is between 5nm and 200nm, for example here 20nm.

This step includes thermally exposing (EET1) the thin conductive layer 21 to a temperature T1 greater than, or equal to within 10%, to a temperature T2 at least equal to 300°C for a duration Δt1 greater than, or equal to within 10%, to a second duration Δt2 at least equal to 60min. In this embodiment, the temperature T2 is the temperature of direct bonding of the transparent substrate 2, between 300°C and 400°C, here equal to about 380°C, and the duration Δt2 is equal to about 120min. According to one embodiment, the temperature T1 is equal to about 380°C and the duration Δt1 is equal to about 120min.

According to one embodiment, this step of thermally exposing (EET1) to the temperature T1 for the duration Δt1 is performed while the structure is disposed in the enclosure of the CVD deposition reactor, before injecting the precursors into the enclosure to form the thin protective layer 22. In other words, during this thermal exposure, the precursors are not present.

According to one embodiment, during this step of thermally exposing to the temperature T1 for the duration Δ t1, the enclosure is under vacuum (pressure lower than atmospheric pressure, preferably between 1 and 10 Torr).

With reference to FIG. 2D, the thin conductive track 12 is then made (ELG), by lithography and etching. For this, an etching mask (resin, not represented) is made to define the areas to be etched. Then, the unprotected parts of the thin protective layer 22 and the thin conductive layer 21 are etched, with etch stopping on the oxide of the transparent layer 11. The etching mask is then eliminated. Thus, a thin conductive track 12 covered with a thin protective track 13 is obtained. Only the edges (with a small vertical dimension) of the thin conductive track 12 are exposed, so that the thin protective track 13 ensures protection of the TCO material with respect to the gaseous environment.

With reference to FIG. 2E, an encapsulation layer 14, which extends over and covers the transparent layer 11, the thin protective track 13 and therefore also the thin conductive track 12, is then made (ECE). The encapsulation layer 14 is made of an electrically insulating transparent material, such as an oxide or a nitride. It is preferably a material having the same refractive index as that of the thin protective track 13 and the thin conductive track 12, so as to limit the parasitic reflections. This is preferably TEOS. Its thickness from the transparent layer 11 may be from several hundred nanometers to a few microns, for example equal to about 1µm. A step of planarizing its upper face is performed with a view to direct bonding, for example in a chemical mechanical manner (CMP).

With reference to FIG. 2F, assembling a transparent substrate 2, here of glass, is performed on the free face of the encapsulation layer 14, by direct bonding. Consolidation annealing (EET2) is performed at a temperature T2 higher than the ambient temperature, at least higher than 300°C, preferably between 300°C and 400°C, for a duration Δt2 at least equal to 60 min, here at 380°C for 120 min. Consolidation annealing can be performed during or after contacting the surfaces to be bonded.

Thus, the transparent optical structure 10, herein made of the transparent layer 11, of the thin conductive track 12 covered with the thin protective track 13, of the encapsulation layer 14, to which the transparent substrate 2 is assembled by temperature-assisted direct bonding, is obtained.

With reference to FIG. 2G, manufacture of the optical diffuser 100 is then completed. For this, a second anti-reflective layer 4 is made, herein on the upper face of the transparent substrate 2. Like the first anti-reflective layer 3, it can be made by alternating SiN and SiO sublayers. Next, a temporary handle (not represented) is assembled to the free upper face of the anti-reflective layer 4, and the support substrate 20 is removed, for example by grinding followed by wet clean.

Finally, conductive vias 24 are made, which each extend vertically through the anti-reflective layer 3 and the transparent layer 11, to come into electrical contact with an end of the thin conductive track 12. In this example, the conductive vias 24 each come into contact with a lower face of a conductive portion 23, for example made of TiN, the upper face of which is in electrical contact (and here in physical contact) with the thin conductive track 12. Connection pads 25 (OPM, Over Pad Metallization) are then made at the lower face of the anti-reflective layer 3, in electrical contact with the conductive vias 24. Finally, the temporary handle is removed.

In the case of a method for collectively (i.e., simultaneously) manufacturing a plurality of transparent optical structures 10, and herein optical diffusers 1, from the same wafer, the method ends with dicing so as to separate the optical diffusers 1 from each other. It is therefore understood that the steps described above are performed at the scale of the wafer.

One, and herein several, transparent optical structures 10 are thus obtained, the material of the thin conductive layer 21 of which has been protected by the thin protective layer 22 during the steps of the manufacturing method, in particular during the steps of resist stripping and wet cleaning. It appears that the presence of this protection makes it possible to reduce degradation in the optical and electrical properties of the thin conductive track, both in terms of spatial uniformity at the scale of the wafer, and at the level of each transparent optical structure 10.

As such, series of measurements of the optical properties (refractive index n and extinction coefficient k) of the TCO material (herein ITO) have been performed by ellipsometry at a wavelength of 940nm, at the wafer scale.

A first series of measurements is performed in the case where the manufacturing method includes the following steps: step EPVD of making the thin conductive layer 21, herein of ITO with a thickness of 40nm, by PVD at 150°C; step ECVD of making the thin protective layer 22 of TEOS of 20nm by PECVD under vacuum, with thermal exposure EET1 at 380°C (T1) for 120min (Δ t1); lithography and etching step ELG to form the thin conductive track 12 and the thin protective track 13; step ECE of making the encapsulation layer 14 of 1µm TEOS; step EET2 of thermally exposing at 380°C (T2) for 120min (Δt2) during direct bonding of the glass substrate 2.

Here, no specific thermal exposure at 380°C for 120min is performed between steps EPVD and ECVD (i.e., between leaving the PVD reactor and introducing into the CVD reactor), nor between step ECVD step and step EET2.

Measurements are performed immediately after step EPVD. The extinction coefficient k has a mean value of 0.063 and a relative standard deviation of 9.6%, and the refractive index n has a mean value of 1.61 and a relative standard deviation of 0.5%.

After step EET2, the extinction coefficient k has a mean value of 0.059 and a relative standard deviation of 1.2%. The spatial measurements of the refractive index n give a mean value of 1.61 and a relative standard deviation of 0.1%.

Thus, the spatial dispersion of the optical properties is significantly reduced compared to previous measurements. It is therefore understood that the optical (and therefore electrical) properties of the conductive material have been preserved during the manufacturing method.

A second series of measurements is performed, in the case where the manufacturing method includes the same steps as the method of the first series of measurements, but further includes an annealing step R1′ performed between step ECVD and EET1 and step ELG. For this, the structure is placed in a specific annealing furnace, which is herein the same as that used during the direct bonding step EET2.

After step EET2, the extinction coefficient k has a mean value of 0.059 and a relative standard deviation of 0.8%, and the refractive index n has a mean value of 1.61 and a relative standard deviation of 0.1%. It appears that the spatial dispersion of the optical and therefore electrical properties is also greatly reduced, which makes it possible to show that the optical and electrical properties of the conductive material have been preserved.

A third series of measurements is performed, in the case where the manufacturing method comprises the same steps as the method of the first series of measurements, but further includes an annealing step R1 performed between step EPVD and step ECVD/EET1. For this, as previously, the structure is placed in a specific annealing furnace, which is herein the same as that used during the direct bonding step EET2.

After step EET2, the extinction coefficient k has a mean value of 0.051 and a relative standard deviation of 16.0%, and the refractive index n has a mean value of 1.62 and a relative standard deviation of 0.9%. It appears that the spatial dispersion in the optical and therefore electrical properties is reduced compared to values obtained directly after step EPVD, but less significantly than in the case of the first and second series of measurements. Thus, it is also particularly advantageous not to perform a specific annealing between steps EPVD and ECVD/EET1, and therefore to maintain the structure obtained following step EPVD at ambient temperature (less than 100°C, or even 50°C) and at atmospheric pressure, until it is placed in the CVD reactor for step ECVD/EET1.

Embodiments have just been described. Different variants and modifications will appear to those skilled in the art.

A method for manufacturing an transparent optical structure (10) is summarized as including the following steps of: making a transparent layer (11); making (EPVD) a conductive layer (21), made of a transparent and electrically conductive material, on a face of the transparent layer (11); making (ECVD) a protective layer (22), made of a transparent and electrically insulating material, covering the conductive layer (21), by chemical vapor deposition; making (ELG) a conductive track (12), covered with a protective track (13), by lithography and etching the protective layer (22) and the conductive layer (21); making (ECE) an encapsulation layer (14), made of a transparent and electrically insulating material, covering the transparent layer (11), the protective track (13) and the conductive track (12).

Making the protective layer (22) is performed by chemical vapor deposition under vacuum.

Making the protective layer (22) includes thermally exposing (EET1) the conductive layer (21) to a first temperature T1 greater than, or equal to within 10%, to a second temperature T2 at least equal to 300°C for a first duration Δt1 greater than, or equal to within 10%, to a second duration Δt2 at least equal to 60min.

The manufacturing method includes, following the step of making (ECE) the encapsulation layer (14), a step of thermally exposing (EET2) to the second temperature T2 for the duration Δt2.

The step of making the protective layer (22) includes: thermally exposing to the temperature T1 for the duration Δt1, performed in an enclosure of a chemical vapor deposition reactor, formation precursors of the protective layer (22) not being present in the enclosure; and then forming the protective layer (22) in the enclosure by injecting the precursors.

After the structure leaves a layer deposition reactor used during the step of making the conductive layer (21), until introducing the structure into a CVD reactor used during the step of making the protective layer (22), the thin protective layer remains at a temperature less than or equal to 100°C in an environment at atmospheric pressure.

The conductive layer (21) is made of an oxide.

The protective layer (22) is made of a silicon oxide or nitride.

The temperature T1 and the temperature T2 are between 300°C and 400°C.

When making the protective layer (22), the pressure is between 1 and 10 Torr.

The manufacturing method includes a step of assembling a transparent substrate (2) on the encapsulation layer (14), by direct bonding, during which the step of thermally exposing to the temperature T2 is performed for the duration Δt2.

The manufacturing method includes a step of making an additional layer, during which the step of thermally exposing to the temperature T2 is performed for the duration Δt2.

A transparent optical structure (10), is summarized as including: a transparent layer (11); a conductive track (12), extending on a face of the transparent layer (11), made of a transparent and electrically conductive material; a protective track (13), covering a face of the conductive track (12) opposite to the transparent layer (11), made of a transparent and electrically insulating material; an encapsulation layer (14), made of a transparent and electrically insulating material, covering the transparent layer (11), the protective track (13) and the conductive track (12).

The transparent layer (11), the protective track (13) and the encapsulation layer (14) are made of silicon-based materials, and wherein the conductive track (12) is made of a transparent conductive oxide (TCO).

The transparent optical structure (10) further includes a transparent substrate (2) assembled by direct bonding to the encapsulation layer (14), or an additional layer covering the encapsulation layer (14).

The conductive track (12) has a thickness between 5nm and 200nm, and the protective track (13) has a thickness between 5nm and 200nm.

An optical diffuser (100), is summarized as including: the transparent optical structure (10) as discussed above, where the transparent layer (11) is a diffusing layer including diffusing structures (11a) arranged in a main plane of the transparent layer (11) and located in an encapsulating material (11b) having a refractive index different from that of the diffusing structures.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for manufacturing a transparent optical structure, the method comprising:
forming a transparent layer;
forming a conductive layer, which is made of a transparent and electrically conductive material, on a face of the transparent layer;
forming a protective layer, which is made of a transparent and electrically insulating material, on the conductive layer by chemical vapor deposition;
forming a conductive track, covered with a protective track, by lithography and etching the protective layer and the conductive layer;
forming an encapsulation layer, which is made of a transparent and electrically insulating material, on the transparent layer, the protective track, and the conductive track.

2. The method according to claim 1, wherein forming the protective layer is performed by chemical vapor deposition under vacuum.

3. The method according to claim 1, wherein forming the protective layer includes thermally exposing the conductive layer to a first temperature greater than, or equal to within 10%, to a second temperature at least equal to 300°C for a first duration greater than, or equal to within 10%, to a second duration at least equal to 60 minutes.

4. The method according to claim 3, further comprising:
subsequent to forming the encapsulation layer, thermally exposing to the second temperature for the second duration.

5. The method according to claim 3, wherein forming the protective layer includes:
thermally exposing to the first temperature T1 for the first duration, performed in an enclosure of a chemical vapor deposition reactor, formation precursors of the protective layer not being present in the enclosure; and
forming the protective layer in the enclosure by injecting the precursors.

6. The method according to claim 1, wherein, after the transparent optical structure leaves a layer deposition reactor used during forming the conductive layer, until introducing the transparent optical structure into a Chemical Vapor Deposition (CVD) reactor used during forming the protective layer, the protective layer remains at a temperature less than or equal to 100°C in an environment at atmospheric pressure.

7. The method according to claim 1, wherein the conductive layer is made of an oxide.

8. The method according to claim 1, wherein the protective layer is made of a silicon oxide or nitride.

9. The method according to claim 3, wherein the first temperature T1 and the second temperature T2 are between 300°C and 400°C.

10. The method according to claim 1, wherein, when forming the protective layer, the pressure is between 1 and 10 Torr.

11. The method according to claim 4, further comprising:
assembling a transparent substrate on the encapsulation layer, by direct bonding, during which the thermally exposing to the second temperature T2 is performed for the second duration.

12. The method according to claim 4, further comprising:
forming an additional layer, during which the thermally exposing to the second temperature is performed for the second duration.

13. A transparent optical structure, comprising:
a transparent layer;
a conductive track, extending on a face of the transparent layer, made of a transparent and electrically conductive material;
a protective track, covering a face of the conductive track opposite to the transparent layer, made of a transparent and electrically insulating material; and
an encapsulation layer, made of a transparent and electrically insulating material, covering the transparent layer, the protective track, and the conductive track.

14. The transparent optical structure according to claim 13, wherein
the transparent layer, the protective track, and the encapsulation layer are made of silicon-based materials, and
the conductive track is made of a transparent conductive oxide.

15. The transparent optical structure according to claim 13, further comprising:
a transparent substrate assembled by direct bonding to the encapsulation layer, or an additional layer covering the encapsulation layer.

16. The transparent optical structure according to claim 13, wherein the conductive track has a thickness between 5nm and 200nm, and the protective track has a thickness between 5nm and 200nm.

17. An optical diffuser, comprising:
a transparent layer;
a conductive track, extending on a face of the transparent layer, made of a transparent and electrically conductive material;
a protective track, covering a face of the conductive track opposite to the transparent layer, made of a transparent and electrically insulating material; and
an encapsulation layer, made of a transparent and electrically insulating material, covering the transparent layer, the protective track, and the conductive track,
wherein the transparent layer is a diffusing layer including diffusing structures arranged in a main plane of the transparent layer and located in an encapsulating material having a refractive index different from that of the diffusing structures.

18. The optical diffuser according to claim 17, wherein
the transparent layer, the protective track, and the encapsulation layer are made of silicon-based materials, and
the conductive track is made of a transparent conductive oxide.

19. The optical diffuser according to claim 17, further comprising:
a transparent substrate assembled by direct bonding to the encapsulation layer, or an additional layer covering the encapsulation layer.

20. The optical diffuser according to claim 17, wherein the conductive track has a thickness between 5nm and 200nm, and the protective track has a thickness between 5nm and 200nm.
